(19) United States
(12) Patent Application Publication
(10) Pub. No.: US 2024/0411249 A1
(43) Pub. Date: Dec. 12, 2024

(54) FIXING DEVICE AND IMAGE FORMING APPARATUS

(71) Applicant: Oki Electric Industry Co., Ltd., Tokyo (JP)

(72) Inventor: Tetsuya WATANABE, Tokyo (JP)

(73) Assignee: Oki Electric Industry Co., Ltd., Tokyo (JP)

(21) Appl. No.: 18/662,055

(22) Filed: May 13, 2024

(30) Foreign Application Priority Data
Jun. 8, 2023 (JP) 2023-94639

(51) Int. Cl. G03G 15/20

(52) U.S. Cl. CPC G03G 15/2017; G03G 15/2064

(57) ABSTRACT

A fixing section includes: a fixing belt that heats a developer image transferred to a recording medium to fix the developer image onto the recording medium; a heater that generates heat, the heater being disposed inside the fixing belt; a heat diffusion member that conducts heat from the heater to the fixing belt; and temperature sensors that detect a temperature of the heat diffusion member to determine a temperature of the fixing belt.

### BACKGROUND OF THE INVENTION

### 1. Field of the Invention

The present disclosure relates to a fixing device and an image forming apparatus.

### 2. Description of the Related Art

Conventionally, an electrophotographic image forming apparatus employs a fixing device to heat a toner, which serves as a developer, thereby fixing it onto a medium. In the fixing device, a fixing belt is heated by a heater. In order to securely fix the toner to the medium, it is necessary to accurately detect the temperature of the fixing belt.

In the conventional technology, for example, as described in Japanese Patent Application Publication No. 2022-115000, a heat storage member is provided on the back side of the heater in contact with the fixing belt (in other words, on the opposite side of the fixing belt) so as to store heat from the heater. The temperature is detected from the back side of the heat storage member, in other words, from the back side of the heater.

### SUMMARY OF THE INVENTION

However, when the temperature is detected on the back side of the heater, the response to changes in the temperature of the fixing belt associated with a fixing operation is insufficient.

Therefore, it is an object of one or more aspects of the present disclosure to enable the detection of changes in the temperature of a fixing belt associated with a fixing operation with enhanced responsiveness.

A fixing device according to one aspect of the present disclosure includes: a fixing belt that heats a developer image transferred to a recording medium to fix the developer image onto the recording medium; a heat source that generates heat, the heat source being disposed inside the fixing belt; a heat diffusion member that conducts heat from the heat source to the fixing belt; and a temperature detector that detects a temperature of the heat diffusion member to determine a temperature of the fixing belt.

An image forming apparatus according to one aspect of the present disclosure has a fixing device including: a fixing belt that heats a developer image transferred to a recording medium to fix the developer image onto the recording medium; a heat source that generates heat, the heat source being disposed inside the fixing belt; a heat diffusion member that conducts heat from the heat source to the fixing belt; and a temperature detector that detects a temperature of the heat diffusion member to determine a temperature of the fixing belt.

According to one or more aspects of the present disclosure, the changes in the temperature of the fixing belt associated with a fixing operation can be detected with enhanced responsiveness.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of a cross section schematically illustrating a configuration of a color printer as an image forming apparatus according to an embodiment;

FIGS. 2A and 2B are schematic diagrams for explaining a fixing belt and a heater;

FIG. 3 is a first schematic diagram of a pressurizing roller and the fixing belt viewed from their side;

FIGS. 4A and 4B are schematic diagrams for explaining an arrangement of a heat diffusion member, resistance elements, temperature sensors, and thermostats;

FIG. 5 is a second schematic diagram of the pressurizing roller and the fixing belt viewed from their side;

FIGS. 6A and 6B are schematic diagrams for explaining how the temperature changes as a fixing section operates;

FIG. 7 is a block diagram schematically illustrating a configuration of a control system of the color printer;

FIG. 8 is a schematic diagram for explaining configurations of the resistance elements; and

FIGS. 9A and 9B are block diagrams illustrating examples of hardware configurations.

### DETAILED DESCRIPTION OF THE INVENTION

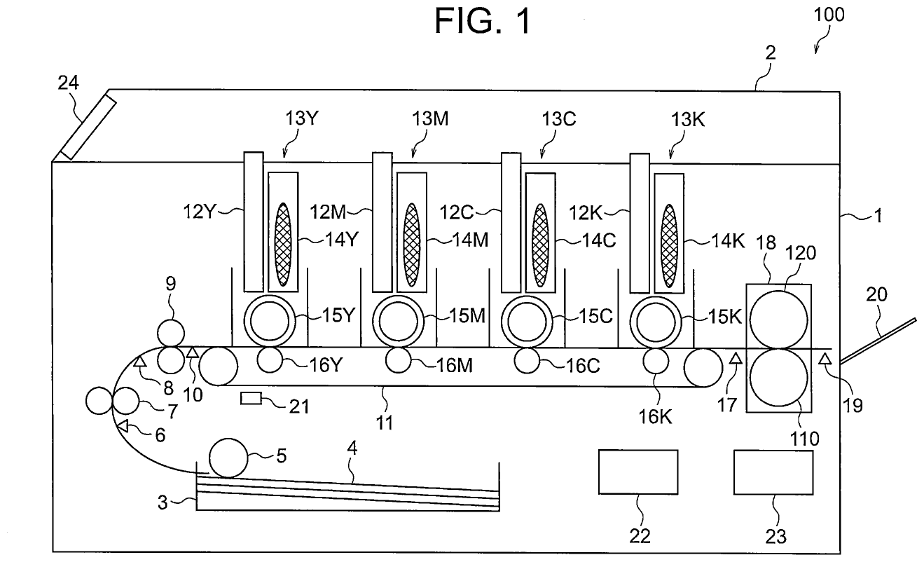

FIG. 1 is a side view of a cross section illustrating a schematic configuration of a color printer 100 as an image forming apparatus according to an embodiment. The color printer 100 includes a main body 1 and a top cover 2 that can be opened and closed with respect to the main body 1.

A recording medium storage section 3 stores recording media 4, which are media for recording. The recording media 4 are sheets or the like on which the color printer 100 performs printing.

A sheet feed roller 5 is a roller used to feed the recording media 4 from the recording medium storage section 3 one by one.

First resist rollers 7 and second resist rollers 9 are conveyance rollers that convey the recording medium 4 fed by the sheet feed roller 5 from the recording medium storage section 3 to image forming sections 13Y, 13M, 13C, and 13K.

A first IN sensor 6 is a running sensor that senses the arrival of the recording medium 4 and is installed in front of the first resist rollers 7.

A second IN sensor 8 is a running sensor that senses the arrival of the recording medium 4 and is installed in front of the second resist rollers 9.

A WR sensor 10 is a running sensor that senses the recording medium 4 and is installed behind the second resist rollers 9. The WR sensor 10 can sense timings of arrival of the recording medium 4 at the image forming sections 13Y, 13M, 13C, and 13K.

A conveyance belt 11 is an endless belt that conveys the fed recording medium 4 to a downstream side of the image forming sections 13Y, 13M, 13C, and 13K.

LED heads 12Y, 12M, 12C, and 12K and the image forming sections 13Y, 13M, 13C, and 13K are provided above the conveyance belt 11.

Here, in FIG. 1, the configurations related to colors, namely, Yellow, Magenta, Cyan and black, are indicated by capital letters Y, M, C and K appended at the ends of their reference characters, respectively. In the following, the capital letters Y, M, C, and K appended to the ends of the reference characters may be omitted in a case where there is no particular need to identify the color.

Each of the LED heads 12Y, 12M, 12C, and 12K is an exposure section that applies light in response to printing data serving as image forming data. The LED heads 12Y, 12M, 12C, and 12K are supported by holders for the respective colors that can be moved and installed onto the top cover 2 capable of being opened and closed, corresponding to each color.

Each of the LED heads 12Y, 12M, 12C, and 12K can perform exposure when the top cover 2 is closed. Each of the LED heads 12Y, 12M, 12C, and 12K is connected to the main body 1 of the color printer 100 via a cable.

Each of the image forming sections 13Y, 13M, 13C, and 13K forms a toner image, i.e., a developer image, using the toner, which is a developer for each color.

Since the respective image forming sections 13Y, 13M, 13C, and 13K are configured in a similar manner, only the image forming section 13Y will be described below by way of example.

The image forming section 13Y forms a toner image by depositing the toner stored inside a toner cartridge 14Y onto a photosensitive drum 15Y on which an electrostatic latent image has been formed by the LED head 12Y.

Here, the toner cartridge 14Y has a mechanical structure that is detachable from inside the color printer 100 because it needs to be replaced when toner runs out.

The photosensitive drum 15Y is a photoconductor capable of creating the electrostatic latent image, corresponding to printing data, on its drum surface using electrostatic force.

Transfer rollers 16Y, 16M, 16C, and 16K are rollers disposed to face the photosensitive drums 15Y, 15M, 15C, and 15K across the conveyance belt 11, respectively. The transfer rollers 16Y, 16M, 16C, and 16K are transfer sections that transfer the respective toner images formed on the surfaces of the photosensitive drums 15Y, 15M, 15C, and 15K, onto the recording medium 4.

The photosensitive drums 15Y, 15M, 15C, and 15K and the transfer rollers 16Y, 16M, 16C, and 16K enable the electrophotographic processes such as electrostatic charging, development and transfer by receiving high voltage applied by a high-voltage power supply 22 described later.

A FUSER-IN sensor 17 is a running sensor that senses the recording medium 4 and is installed intermediately before a fixing section 18.

The fixing section 18 is a fixing device that fixes the toner image transferred on the recording medium 4 by heat and pressure. The fixing section 18 includes a pressurizing roller 110 and a fixing belt 120.

An EXIT sensor 19 is a running sensor that senses the recording medium 4 and is installed behind the fixing section 18. The EXIT sensor 19 senses the ejection of the recording medium 4 from the fixing section 18.

An ejection stacker 20 is a stacker from which the recording medium 4 is finally ejected.

A density sensor 21 is an optical sensor that reads a special pattern created on the conveyance belt 11 in order to perform a print quality maintaining operation such as density correction.

The high-voltage power supply 22 is a power supply that generates high voltage to be applied to the photosensitive drums 15Y, 15M, 15C, and 15K and the transfer rollers 16Y, 16M, 16C, and 16K.

A low-voltage power supply 23 is an AC-DC power supply that converts commercial AC power to DC power. The low-voltage power supply 23 supplies a DC voltage such as 3.3 V, 5 V, or 24 V, to each board (not illustrated). It also supplies AC 100 V to a heat source of the fixing section 18 via a triac.

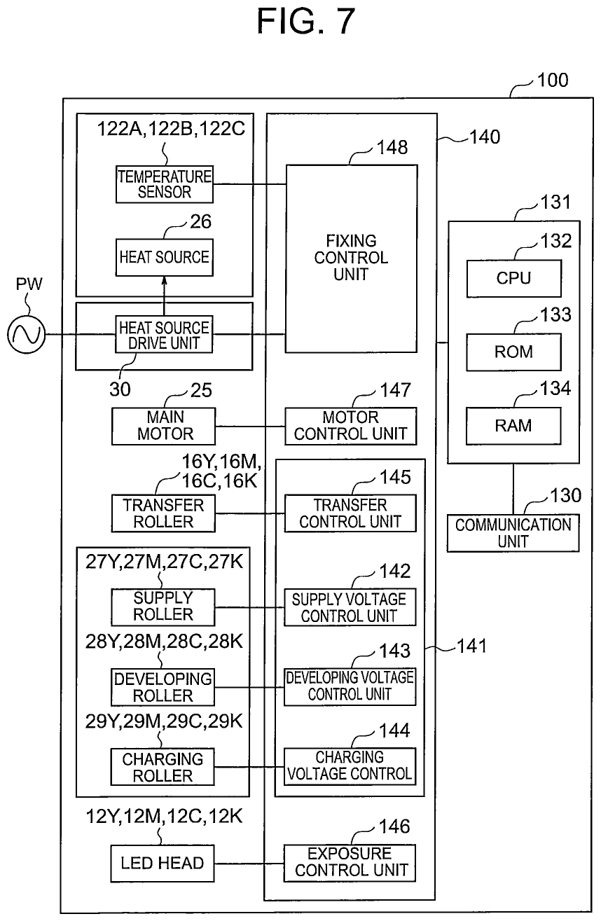

Here, the above-mentioned running sensors, including the first IN sensor 6, the second IN sensor 8, the WR sensor 10, the FUSER-IN sensor 17 and the EXIT sensor 19, are connected to a controller 131 (see FIG. 7) via cables.

The rollers, including the sheet feed roller 5, the first resist rollers 7, the second resist rollers 9, the photosensitive drums 15, the transfer rollers 16, and the pressurizing roller 110, are mechanically driven by actuators (not illustrated), and they are capable of conveying the recording medium 4 in the downstream direction.

A display input section 24 is a printed circuit board composed of a liquid crystal display panel and switches, etc., and functions as a display section for displaying the status of the color printer 100 and as an input section for receiving an input operation by a user. The display input section 24 is connected to the controller 131 via a cable. The liquid crystal display panel can display characters such as 24 characters×2 lines, for example.

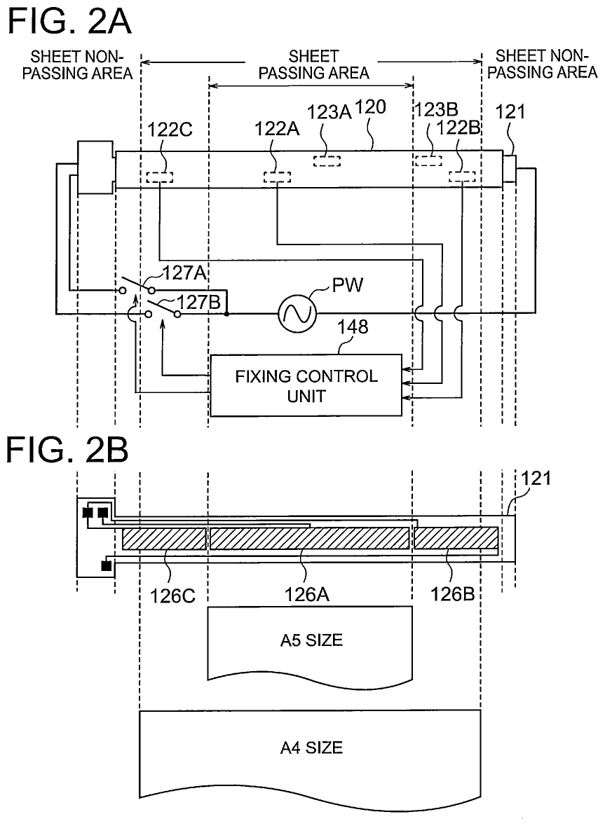

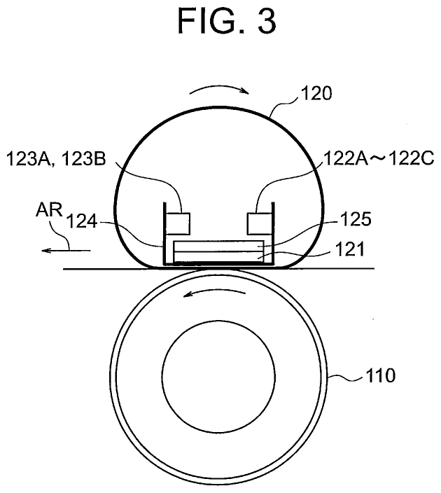

The internal configuration of the fixing section 18 is described here using FIGS. 2 and 3.

FIG. 2A is a schematic diagram of the fixing belt 120 viewed from above, and FIG. 2B is a schematic diagram of a heater 121 in the fixing belt 120. FIG. 3 is a schematic diagram of the pressurizing roller 110 and the fixing belt 120 viewed from their side.

As illustrated in FIGS. 2A and 3, the fixing belt 120 has therein the heater 121, temperature sensors 122A, 122B, and 122C, thermostats 123A and 123B, a heat diffusion member 124, and a heat conduction member 125.

Although not illustrated in the figure, a heater holder for fixing the heater 121 and a fixing support member for supporting the fixing belt 120 are provided inside the fixing belt 120.

The pressurizing roller 110 is disposed to face the fixing belt 120 and forms a nip portion between the fixing belt 120 and the pressurizing roller 110. Thus, the pressurizing roller 110 pressurizes the recording medium 4 from outside the fixing belt 120 in the direction of the fixing belt 120.

Here, the pressurizing roller 110 has a cylindrical member made of metal material with a peripheral surface of the member covered by a rubber elastic layer. The rubber elastic layer is made of, for example, silicon rubber or the like. Since the nip portion is formed between the fixing belt 120 and the pressurizing roller 110, the rotation of the pressurizing roller 110 by a main motor 25 (FIG. 7) described later also causes the fixing belt 120 to rotate.

The fixing belt 120 is an endless strip and is supported from the inside by the fixing support member. The fixing belt 120 heats the toner image transferred to the recording medium 4 in order to fix the toner image onto the recording medium 4.

The fixing belt 120 includes, from the inside, a base material, a rubber layer, and a mold release layer. The base material is composed of, for example, a heat-resistant resin such as polyimide or a Stainless Used Steel (SUS), which is stainless steel. The rubber layer is composed of silicon rubber or the like. The mold release layer is composed of a fluorinated resin such as Perfluoroalkosy Alkane (PFA).

The heater 121 is a heat source disposed inside the fixing belt 120. Here, the heater 121 is a surface heating element that extends in the longitudinal direction and generates heat. For example, the heater 121 generates heat when resistance elements 126A, 126B, and 126C formed on a substrate receive a voltage from the substrate; specifically, each resistance element is configured by stacking an electrical insulation layer, a resistance heating layer, an electrode, and a protection layer in this order on a SUS substrate. Instead of SUS, a ceramic with excellent insulating properties may be used.

As illustrated in FIG. 2B, within the heater 121, the resistance element 126A is formed at the center, and the resistance elements 126B and 126C are separately formed at each end of the heater.

The resistance element 126A at the center is designed to be wide enough to heat a recording medium with a narrow size (e.g., A5 size). Meanwhile, a combination of the resistance element 126A at the center and the resistance elements 126B and 126C at each end is designed to be wide enough to heat recording media with a wide size (e.g., A4 size). The resistance elements 126A, 126B, and 126C are heating elements that are independently supplied with electric power from an AC commercial power supply PW by being controlled ON or OFF with the triac or the like as described later.

As illustrated in FIG. 3, the heat diffusion member 124 conducts heat from the heater 121 to the fixing belt 120. Here, the heat diffusion member 124 is disposed between the heater 121 and the fixing belt 120 in order to evenly distribute the heat from the heater 121, ensuring a uniform temperature across both the longitudinal and width directions. The width direction is, for example, the direction indicated by arrow AR in FIG. 3, and is a direction in which the recording medium 4 is conveyed. The heat diffusion member 124 is in contact with the heater 121 and the fixing belt 120 so as to conduct heat. The heat diffusion member 124 is in contact with them even when a lubricant such as sliding grease is applied between the heat diffusion member 124 and either the heater 121 or the fixing belt 120.

Here, the heat diffusion member 124 is formed of a material with high thermal conductivity such as aluminum in order to be heated by the heater 121 and to accurately and responsively detect the temperature of the fixing belt 120 which loses heat to the recording medium 4 or the like.

The heat conduction member 125 is disposed to contact the heater 121. The purpose of providing the heat conduction member 125 is the same as that of the heat diffusion member 124, and its material is, for example, aluminum with high thermal conductivity.

When the heat diffusion by the heat diffusion member 124 is sufficient, the heat conduction member 125 may be formed of stainless steel or the like, or the heat conduction member 125 may be omitted.

The temperature sensors 122A, 122B, and 122C are temperature detectors that detect the temperature of the heat diffusion member 124 in order to determine the temperature of the fixing belt 120. Here, the temperature sensors 122A, 122B, and 122C are in contact with the heat diffusion member 124. In particular, the temperature sensors 122A, 122B, and 122C detect the temperature of the heat diffusion member 124 to determine the temperature of the fixing belt 120 at the nip portion formed between the fixing belt 120 and the pressurizing roller 110.

The temperature sensor 122A is disposed at the center of a sheet passing area, and the temperature sensors 122B and 122C are disposed at ends of the sheet passing area, with one sensor at each end. Here, the temperature sensor 122B is provided to measure the temperature heated by a resistance element 126B on the right side illustrated in FIG. 2B, and the temperature sensor 122C is provided to measure the temperature heated by a resistance element 126C on the left side illustrated in FIG. 2B. Since the resistance elements 126B and 126C are heated simultaneously, only one of the temperature sensors 122B and 122C may be provided.

The thermostats 123A and 123B as final safety devices are provided to contact the heat diffusion member 124 in the fixing belt 120, in the same manner as the temperature sensors 122A, 122B, and 122C.

Here, the thermostat 123B is provided to detect the temperature heated by the resistance element 126B on the right side illustrated in FIG. 2B, but instead of or together with the thermostat 123B, a thermostat (not illustrated) may be provided to detect the temperature heated by the resistance element 126C on the left side.

The temperature sensors 122A, 122B, and 122C and the thermostats 123A and 123B are pressed against the heat diffusion member 124 with a predetermined force by using a spring (not illustrated) in order to reduce detection temperature errors and improve response.

The AC commercial power supply PW supplies an AC input voltage. The AC input voltage here is AC 100 V.

Triacs 127A and 127B are semiconductor switching elements used to control the power for the heater 121. The triacs 127A and 127B receive ON or OFF control from a fixing control unit 148 (see FIG. 7) each. The details of the fixing control unit 148 will be described later, but the fixing control unit 148 uses the resistance elements 126A, 126B, and 126C generating heat within the heater 121 for the control of heating, based on detection results of the respective temperature sensors 122A, 122B, and 122C, and thereby performing control so that the temperature of the fixing belt 120 becomes optimal.

Heat conduction grease (not illustrated) is applied between the heater 121 and the heat diffusion member 124 and between the heater 121 and the heat conduction member 125 to improve thermal conductivity between the members. The heat conduction grease is mainly composed of zinc oxide and silicone oil. Sliding grease (not illustrated) is also applied between the heat diffusion member 124 and the fixing belt 120. The sliding grease is mainly composed of perfuluoropolyether (PTFE). Since a lubricant such as the sliding grease is intended for use with the assumption of the contact between the heat diffusion member 124 and the fixing belt 120, it is understood that the heat diffusion member 124 and the fixing belt 120 are in contact with each other even when the lubricant is applied.

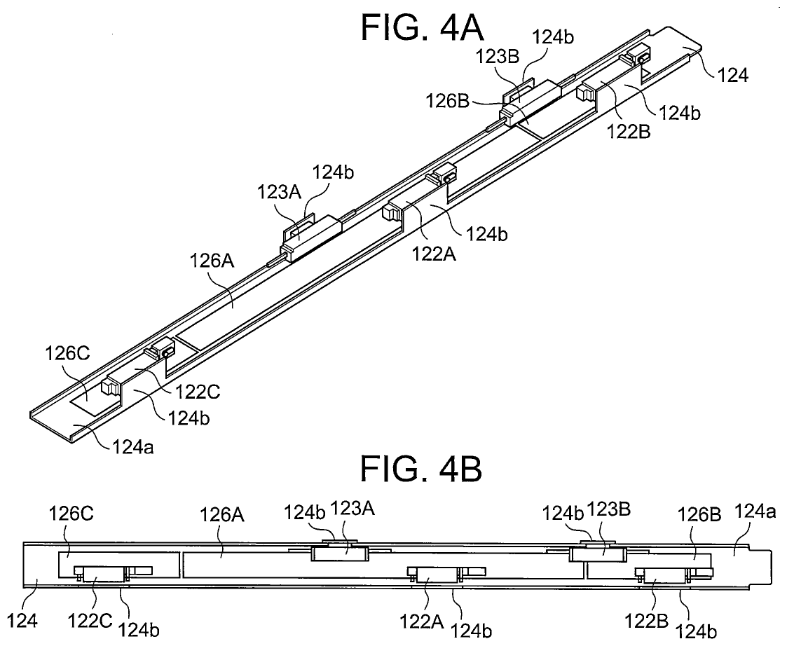

FIGS. 4A and 4B are schematic diagrams for explaining the arrangement of the heat diffusion member 124, the resistance elements 126A, 126B, and 126C, the temperature sensors 122A, 122B, and 122C, and the thermostats 123A and 123B.

FIG. 4A is a diagonal view and FIG. 4B is a top view.

The heat diffusion member 124 has a bottom surface 124a as a plate-shaped member that contacts the fixing belt 120 to apply heat from the resistance element 126A or the resistance elements 126A, 126B and 126C to the fixing belt 120.

The heat diffusion member 124 has wall portions 124b serving as the extension members that extend upward from the bottom surface 124a, only at locations where the temperature sensors 122A, 122B, and 122C and the thermostats 123A and 123B are disposed, as illustrated in FIGS. 4A and 4B, in order to detect heat from the resistance element 126A or from the resistance elements 126A, 126B and 126C, as well as heat which is cooled by the recording medium 4 while passing, by using the temperature sensors 122A, 122B, and 122C and the thermostats 123A and 123B. In other words, the wall portion 124b is provided at a location where the temperature is detected, but not provided at a location where the temperature is not detected. As illustrated in FIGS. 4A and 4B, each wall portion 124b extends in a direction opposite to the fixing belt 120.

The temperature sensors 122A, 122B, and 122C and the thermostats 123A and 123B are attached onto the wall portions 124b. The wall portions 124b only need to be large enough to contact the temperature sensors 122A, 122B, and 122C and the thermostats 123A and 123B, thereby enabling temperature detection using them. This is because, if a part of the wall portion where the temperature is not detected is also extended upward, the heat capacity will increase by the amount of extension, leading to a demand for the wasteful supply of heat.

Next, the characteristics of the temperature in the fixing section 18 will be described.

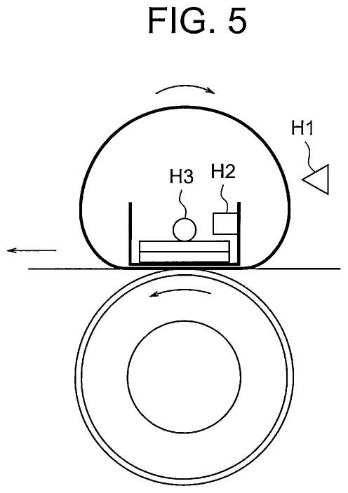

FIG. 5 is a schematic view of the pressurizing roller 110 and the fixing belt 120 from their side, as in FIG. 3, but the illustration of the thermostats 123A and 123B is omitted.

In FIG. 5, H1 is defined as an inlet-side temperature, which is a surface temperature of the fixing belt 120 at an inlet side for the recording medium 4, H2 is the temperature of the heat diffusion member 124 detected by any of the temperature sensors 122A, 122B, and 122C, and H3 is defined as the temperature at the back side of the heat conduction member 125, detected in a conventional technology.

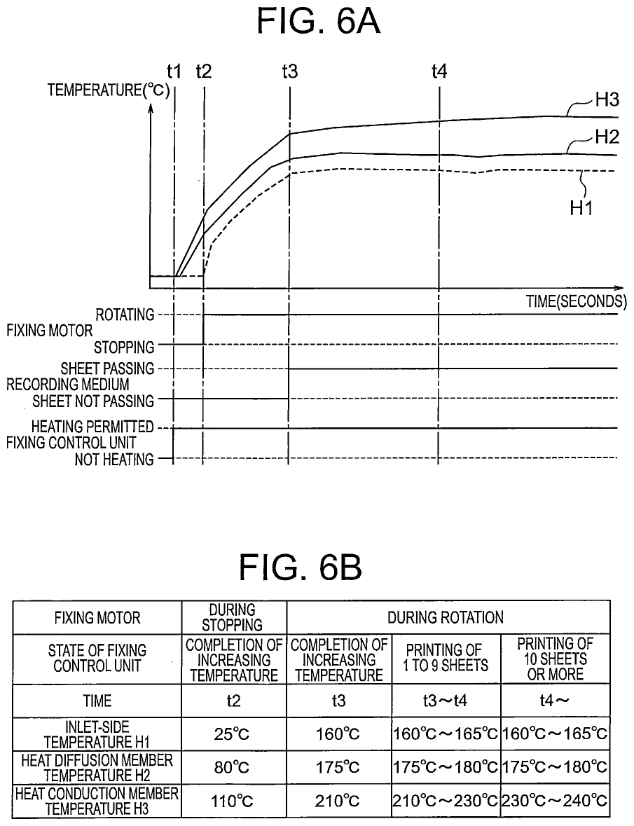

FIG. 6A is a time chart showing how the respective temperatures illustrated in FIG. 5 change as the fixing section 18 operates. FIG. 6B is a table summarizing each temperature in the time chart shown in FIG. 6A.

First, at time t1, the fixing control unit 148 gives permission to heat and causes the heater 121 to heat.

At time t2, the fixing control unit 148 controls the heater to continue heating until the temperature of the nip portion of the fixing belt 120 reaches a predetermined temperature, and it then causes the main motor 25 to rotate, illustrated in FIG. 7, once the temperature reaches the predetermined temperature. This is because the temperature must be raised to the temperature at which the sliding agent applied between the heat diffusion member 124 and the fixing belt 120 softens. Here, the predetermined temperature is set at 80° C. When the temperature H2 of the heat diffusion member 124 reaches 80° C. or higher, the main motor 25 rotates.

At time t3, the fixing control unit 148 controls the heater to continue heating until the temperature of the fixing belt 120 reaches the predetermined temperature, and it then begins to pass the recording medium 4 and initiates printing once the predetermined temperature is reached. Here, the predetermined temperature is set at 160° C. When the inlet-side temperature H1 of the fixing belt 120 reaches 160° C., a sheet begins to be passed.

Time t4 is defined as the time when 10 sheets of recording media 4 have been passed.

Next, referring to FIG. 6B, a description will be given of an advantage of a method of using the heat diffusion member 124 for detecting the temperature of the fixing belt 120.

First, at time t2, the inlet-side temperature H1 of the fixing belt 120 becomes room temperature (25° C.) because the fixing belt 120 is not rotating. Therefore, the temperatures of the fixing belt 120 and the nip portion of the fixing belt 120 cannot be detected at the inlet side of the fixing belt 120.

As illustrated in FIG. 6B, it is possible to detect the temperature H2 of the heat diffusion member 124 as the temperature of the nip portion of the fixing belt 120.

The temperature H3 on the back side of the heat conduction member 125 can also be detected, but as illustrated in FIG. 6B, the temperature H3 is higher than the temperature of the nip portion of the fixing belt 120. As illustrated in FIG. 3, when the position of the heater 121 is used as the reference, the heat capacity in the direction toward the nip portion differs from the heat capacity in the direction opposite to the nip portion, and the heat capacity in the direction opposite to the nip portion is smaller than the heat capacity in the direction toward the nip portion. Thus, the temperature H3 of the heat conduction member 125 is higher than the temperature of the nip portion of the fixing belt 120. Since a SUS substrate is used in the heater 121, its thermal conductivity is lower than that of the heat diffusion member 124, which is made of aluminum. Therefore, this results in a configuration where changes in the temperature of the nip portion are difficult to transmit.

As described above, it is suitable to use the heat diffusion member 124 to detect the temperature when heating is performed in a state where the main motor 25 is in a stopped state.

Next, from time t3 to time t4 and after time t4, the inlet-side temperature H1 of the fixing belt 120 and the temperature H2 of the heat diffusion member 124 differ from each other, but are similar in the variation range.

On the other hand, the temperature H3 on the back side of the heat conduction member 125 increases as the number of printed sheets of the recording media 4 increases. This is because, when the position of the heater 121 is used as the reference, the heat capacity in the direction toward the nip portion is different from the heat capacity in the direction opposite to the nip portion, and the heat capacity in the direction opposite to the nip portion is smaller than the heat capacity in the direction toward the nip portion, so that the temperature H3 of the heat conduction member 125 is higher than the temperature of the nip portion of the fixing belt 120. Furthermore, this is also because the SUS substrate is used in the heater 121, and its thermal conductivity is lower than that of the heat diffusion member 124 made of aluminum, resulting in a configuration where changes in the temperature of the nip portion are difficult to transmit.

Therefore, it is suitable to detect the temperature at the inlet-side of the fixing belt 120 and the heat diffusion member 124 when the main motor 25 heats up in the rotating state and in the recording medium passing state.

Since the temperature at the nip portion of the fixing belt 120 in the stopped state cannot be detected by using the inlet-side temperature H1 of the fixing belt 120, it is necessary to further detect the temperature H3 of the heat conduction member 125 in order to perform control at the inlet-side temperature H1 of the fixing belt 120. This increases the number of temperature sensors required.

When printing is performed at a slow printing speed, it takes time for a portion of the fixing belt 120 that nips the recording medium 4 to reach the inlet side where the temperature is detected. Therefore, the heat in the portion of the fixing belt 120 is reduced due to heat dissipation to the air in the fixing section 18, whereby a temperature change that would be steep becomes flattened. Thus, when the printing speed is slow, the inlet-side temperature H1 of the fixing belt 120 is not accurate enough to detect the temperature of the nip portion of the fixing belt 120.

When the temperature is detected using the heat diffusion member 124, the temperature of the nip portion of the fixing belt 120 can be detected whether the main motor 25 is in the stopped state or rotating state, and the temperature of the fixing belt 120 can be accurately detected regardless of its state without adding other temperature sensors.

FIG. 7 is a block diagram schematically illustrating a configuration of a control system of the color printer 100.

Printing data generated by a Personal Computer (PC) (not illustrated) or the like is received by the color printer 100 through a communication unit 130, which is a communication I/F for Universal Serial Bus (USB) or Local Area Network (LAN).

The controller 131 controls the overall operation of the color printer 100. The controller 131 has a Central Processing Unit (CPU) 132, a Read Only Memory (ROM) 133, and a Random Access Memory (RAM) 134, which are connected by an internal bus (not illustrated).

The CPU 132 controls the RAM 134 and a process control unit 140 according to a print processing program stored in the ROM 133.

The ROM 133 is an area for storing the print processing program and is a nonvolatile memory that can hold data even when the color printer 100 is turned off.

The RAM 134 is a volatile memory that stores received printing data, which are erased when the color printer 100 is turned off.

The process control unit 140 includes a high voltage control unit 141, an exposure control unit 146, a motor control unit 147, and a fixing control unit 148, and it controls the printing processes, which are image forming processes, including conveying of the recording medium 4, charging, developing, transferring, fixing, and the like.

The high voltage control unit 141 controls a voltage applied to various rollers to form toner images and transfer the toner images to the recording medium 4.

The high voltage control unit 141 includes a supply voltage control unit 142, a developing voltage control unit 143, a charging voltage control unit 144, and a transfer control unit 145.

The supply voltage control unit 142 controls supply voltages to be applied to supply rollers 27Y, 27M, 27C, and 27K in the image forming sections 13Y, 13M, 13C, 13K.

The developing voltage control unit 143 controls developing voltages to be applied to developing rollers 28Y, 28M, 28C, and 28K in the image forming sections 13Y, 13M, 13C, and 13K.

The charging voltage control unit 144 controls charging voltages to be applied to charging rollers 29Y, 29M, 29C, and 29K in the image forming sections 13Y, 13M, 13C, and 13K.

The Transfer control unit 145 controls transfer voltages to be applied to the transfer rollers 16Y, 16M, 16C, and 16K.

The exposure control unit 146 controls the exposure of LED heads 12Y, 12M, 12C, and 12K.

The motor control unit 147 controls the main motor 25 in the color printer 100 to drive and rotate it. Specifically, the main motor 25 drives the photosensitive drum 15Y, 15M, 15C, and 15K, the pressurizing roller 110 of the fixing section 18, the sheet feed roller 5, the first resist roller 7, and the second resist roller 9. Although only the main motor 25 is used as the motor here, multiple motors may be provided.

The fixing control unit 148 controls the temperature of the nip portion of the fixing belt 120. For example, the fixing control unit 148 supplies power from the AC commercial power source PW to the heater 121 as a heat source 26 by controlling ON and OFF of a heat source drive unit 30 such as a triac of the low-voltage power supply 23 based on the detection results of the temperature sensors 122A, 122B and 122C, thereby controlling the temperature of the nip portion of the fixing belt 120. The fixing control unit 148 maintains a table storing a set temperature, ON Duty parameters, and the like, and controls fixing according to them. The ON Duty represents the time ratio of applying a voltage per predetermined time to each of the resistance elements 126A, 126B, and 126C.

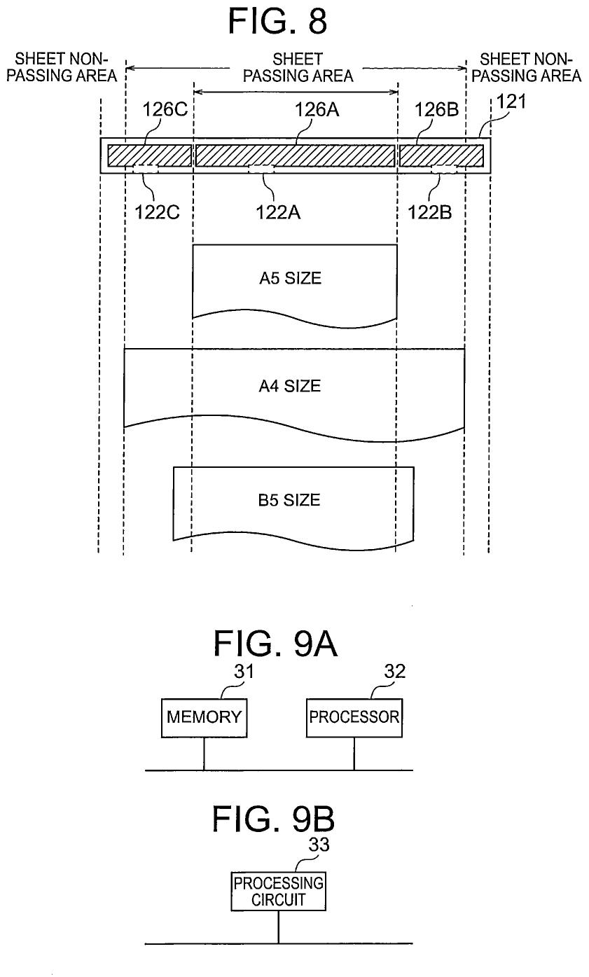

Next, an ON Duty correction of the resistance elements 126A, 126B, and 126C will be described using FIGS. 2 and 8.

Here, the description of a basic operation of the color printer 100 is omitted, and the fixing operation will be mainly described.

The fixing section 18 fixes the toner image formed on the recording medium 4 by heat and pressure. A temperature sensor 122A located at the center of the heat diffusion member 124 detects the temperature at the center of the nip portion of the fixing belt 120.

The fixing control unit 148 controls the power supplied from the low-voltage power supply 23 to the heat source 26 to achieve a predetermined set temperature by driving it ON and OFF via the triacs 127A and 127B. The predetermined set temperature is a set temperature determined for each medium.

The heater 121 as the heat source 26 is divided into the resistance element 126A at the center and the resistance elements 126B and 126C at both ends, which are connected to the AC commercial power source PW via the triacs 127A and 127B.

The triac 127A is connected to the resistance element 126A at the center, and the triac 127B is connected to the resistance elements 126B and 126C at its both ends, so that the triacs 127A and 127B can be controlled independently of each other.

As illustrated in FIG. 8, division positions of the resistance elements 126A, 126B, and 126C are determined by the size of the recording medium to be targeted; here, the length of the resistance element 126A at the center is set to be A5 size width, and the resistance elements 126B and 126C at both ends are used so that the maximum A4 size width can be supported.

The resistance element 126A is driven with the ON Duty such that a temperature detected by temperature sensor 122A becomes the set temperature. Meanwhile, the resistance elements 126B and 126C are driven with an ON Duty obtained by being multiplied by a coefficient that varies depending on the size of recording medium 4 with reference to the ON Duty of the resistance element 126A at the center.

Here, the ON Duty of each of the resistance elements 126B and 126C is determined by the following equation (1), where the ON Duty of each of the resistance elements 126B and 126C is defined as OD and the ON Duty of the resistance element 126A is defined as RD.

$$\\ \begin{matrix}OD = RD \times coefficient CO based on sheet size & ( 1 )\end{matrix}$$

Here, the coefficient CO varies according to the sheet size. For example, the coefficient is defined as CO₁ when the recording medium 4 is A4 size, CO: when the recording medium 4 is B5 size, and CO₃ when the recording medium 4 is A5 size. The relationship among these coefficients is 1≥CO₁>CO₂>CO₃.

By performing the above control, the temperature of the nip portion of the fixing belt 120 can be accurately detected even when the size of the recording media 4 differs, thus ensuring stable print quality even in a case where there are few temperature sensors.

It is noted that in this embodiment, because there is a demand to print a B5 size recording medium 4, while an area where a sheet is passed and an area where the sheet is not passed coexist in each of the resistance elements 126B and 126C, the temperatures of resistance elements 126B and 126C are controlled based on the coefficient RD of the ON Duty of the resistance element 126A. However, this embodiment is not limited to such an example. For example, when the area where the sheet is passed and the area where the sheet is not passed do not coexist, the resistance elements 126B and 126C may be driven with their ON Duties so that the temperature detected by the temperature sensor 122B or 122C becomes the set temperature, in the same manner as the resistance element 126A.

Furthermore, in this embodiment, the heater 121 is divided in the passing direction of sheets, but this embodiment is not limited to such an example. For example, even when a heater that distributes heat in a longitudinal direction is used, it can be controlled in the same manner as above.

Part or all of the process control unit 140 described above can be implemented by a memory 31 and a processor 32 such as a Central Processing Unit (CPU) that executes a program stored in the memory 31, as illustrated in FIG. 9A, for example. Such a program may be provided over a network, or may be provided by being recorded on a recording medium. That is, such a program may be provided, for example, as a program product.

Also, for example, as illustrated in FIG. 9B, part or all of the process control unit 140 can be implemented by a processing circuit 33 such as a single circuit, a composite circuit, a program-operated processor, a program-operated parallel processor, an Application Specific Integrated Circuit (ASIC) or an Field Programmable Gate Array (FPGA).

As described above, the process control unit 140 can be implemented by processing circuitry.

As described above, according to this embodiment, the temperature of the nip portion can be accurately detected using the heat diffusion member 124, thus stabilizing print quality. In addition, since the temperature of the nip portion can be accurately detected both during stopping and during rotating, the detection of the temperature at an inlet of the fixing belt is no longer necessary, and the number of thermistors can be reduced. Thus, the effects of cost reduction and downsizing of the fixing section 18 can be expected.

Although the above-described embodiment is described using the color printer 100 as an example, this embodiment can be applied to image forming apparatuses such as electrophotographic printers, copiers, facsimiles, and multi-function printers with multiple of these functions.

What is claimed is:

1. A fixing device comprising:
a fixing belt that heats a developer image transferred to a recording medium to fix the developer image onto the recording medium;
a heat source that generates heat, the heat source being disposed inside the fixing belt;
a heat diffusion member that conducts heat from the heat source to the fixing belt; and
a temperature detector that detects a temperature of the heat diffusion member to determine a temperature of the fixing belt.

2. The fixing device according to claim 1, wherein the heat diffusion member is disposed between the heat source and the fixing belt.

3. The fixing device according to claim 2, wherein the heat diffusion member is in contact with the fixing belt.

4. The fixing device according to claim 3,
wherein the heat diffusion member includes a plate-shaped member in contact with the fixing belt and the heat source, and an extension member extending from the plate-shaped member in a direction opposite to the fixing belt, and
wherein the temperature detector is attached to the extension member.

5. The fixing device according to claim 1, wherein the heat diffusion member is made of aluminum.

6. The fixing device according to claim 1, wherein the heat source includes a substrate and a heating element formed on the substrate and generating heat when a voltage is applied from the substrate.

7. The fixing device according to claim 1, further comprising: a pressurizing roller that pressurizes the recording medium from outside the fixing belt in a direction of the fixing belt.

8. The fixing device according to claim 2, further comprising: a pressurizing roller that pressurizes the recording medium from outside the fixing belt in a direction of the fixing belt.

9. The fixing device according to claim 3, further comprising: a pressurizing roller that pressurizes the recording medium from outside the fixing belt in a direction of the fixing belt.

10. The fixing device according to claim 4, further comprising: a pressurizing roller that pressurizes the recording medium from outside the fixing belt in a direction of the fixing belt.

11. The fixing device according to claim 7, wherein the temperature detector detects a temperature of the heat diffusion member to determine a temperature of the fixing belt at a nip portion formed between the fixing belt and the pressurizing roller.

12. The fixing device according to claim 8, wherein the temperature detector detects a temperature of the heat diffusion member to determine a temperature of the fixing belt at a nip portion formed between the fixing belt and the pressurizing roller.

13. The fixing device according to claim 9, wherein the temperature detector detects a temperature of the heat diffusion member to determine a temperature of the fixing belt at a nip portion formed between the fixing belt and the pressurizing roller.

14. The fixing device according to claim 10, wherein the temperature detector detects a temperature of the heat diffusion member to determine a temperature of the fixing belt at a nip portion formed between the fixing belt and the pressurizing roller.

15. An image forming apparatus comprising: the fixing device according to claim 1.
